(19) United States
(12) Patent Application Publication
(10) Pub. No.: US 2012/0120658 A1
(43) Pub. Date: May 17, 2012

(54) LED lamp

(76) Inventor: Sylwester D. Wilk, Yonkers, NY (US)

(21) Appl. No.: 12/931,540

(22) Filed: Feb. 2, 2011

Related U.S. Application Data
(60) Provisional application No. 61/413,420, filed on Nov. 13, 2010.

(51) Int. Cl. F21V 29/00; F21S 4/00

(52) U.S. Cl. 362/249.02; 362/373; 362/294

(57) ABSTRACT

LED lighting fixtures are provided, particularly “down” or recessed lighting fixtures and street lamp fixtures. A fan and a heat sink are provided with each fixture and the LED array is attached directly to the heat sink. The fans used preferably are computer cooling fans which are particularly small, efficient and inexpensive. The low-volume exhaust from the fans is released directly into the air space or housing in which the lamps are mounted without the need for special ducting.

This invention relates to LED lamps, and particularly to relatively high power lamps with cooling means for the LED light-producing elements. Priority is claimed from Provisional Patent Application Ser. No. 61/413,420 filed Nov. 13, 2010. The disclosure of that application hereby is incorporated herein by reference.

LED lamps are becoming more popular because they are much more efficient than incandescent or fluorescent lighting, and therefore require much less energy, but also because the LED lamp normally lasts thousands of hours, under normal use, without requiring replacement.

One continuous problem is the initial cost of such lamps. Even though the lamps may be more economical to use, when their purchase price is amortized over the very long life of the lamps, the relatively high initial cost is a deterrent to the purchase and use of such lamps.

A further problem with such lamps is that when LED lamps of relatively high wattage, such as 20 Watts to 100 Watts are used, the LED lamp arrays (the light-producing elements) usually need cooling. Therefore, in some prior LED lamps, relatively expensive, high-throughput fans and ductwork often have been proposed for use in cooling the LED lamp arrays. This equipment is relatively expensive, and it is bulky so that it is difficult to fit the lamps into cramped spaces.

A particular problem exists with recessed lighting or so-called “down lamps.” The fact that the lamps are recessed in the ceiling of a room confines the lamp to fairly cramped quarters and makes the handling and installation of the units relatively difficult and expensive.

Similar problems are suffered by outdoor lighting fixtures such as street lamps.

Therefore, it is an object of the present invention to provide LED lamp structures which remedy or alleviate the foregoing problems.

More particularly, it is an object to provide an LED lamp structure which is relatively inexpensive, compact, and easy to install.

It is a further object of the invention to provide such a lamp structure which eliminates the need for expensive ducting and other ancillary structures.

In accordance with the present invention, the foregoing objectives are met by the provision of a LED lamp fixture with a heat sink structure to which the LED array is attached directly, with a fan mounted nearby. Preferably, the fan is mounted in the hollow interior of the heat sink structure so as to give the lamp a relatively low profile and make the lamp structure compact and relatively easy to fit into recessed spaces.

The fan structure can be comparatively inexpensive and compact in part because the preferred fans are those that have been produced in great quantities for use in computers. Not only are they relatively compact and inexpensive, but the applicant has found that such fans are very efficient in cooling LED lamps.

The applicant has realized also that the fans can be mounted in recessed housings in the air spaces between the ceiling and the floor above it, and discharge the air flow directly into that air space, without use of expensive ducting because the air flow rate is relatively low and the air escapes through natural crevices and cracks in the building structure.

The applicant has applied the same principles to simplifying the construction of outdoor lighting appliances such as street lamps using LED lamps. Cooling fan air is exhausted directly into the housing of the lamp where it easily escapes through natural crevices in the lamp structure.

The great simplification of the air flow structures used in the invention is aided by the efficiency of the heat sink structures used in the invention, thereby minimizing the quantity of airflow required.

The foregoing and other objects and advantages of the invention will be set forth in or apparent from the following description and drawings.

### IN THE DRAWINGS

FIG. 1 is a perspective view of a lamp fixture embodiment of the present invention;

FIG. 2 is a cross-sectional view of the lamp fixture installed in a typical location, with a cross-sectional view of the lamp being taken along Line 2-2 of FIG. 1.

FIG. 3 is a cross-sectional view, like that of FIG. 2, of a different LED lamp fixture of the present invention;

FIG. 4 is a cross-sectional view taken along Line 4-4 of FIG. 3;

FIG. 5 is a perspective view of a heat sink and fan structure used in the lamp fixtures of FIGS. 1-4;

FIG. 6 is a cross-sectional view of another lamp fixture embodiment of the present invention;

FIG. 7 is a broken-away view take along Line 7-7 of FIG. 6; and

FIG. 8 is a top plan view of a component of the structure shown in FIG. 6.

### FLOODLIGHT FIXTURE

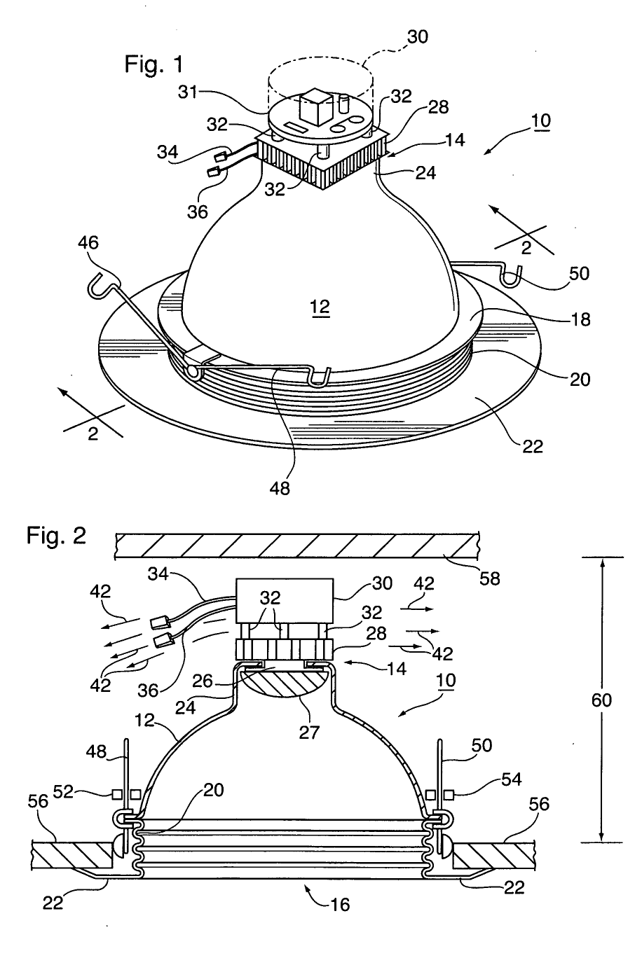

FIG. 1 shows a fixture 10 which is termed herein a “floodlight” fixture, in that it is of the type which normally receives an incandescent or other screw-in type bulb in a socket, and the bulb spreads light outwardly over a relatively wide area.

The fixture includes a bell-shaped housing 12 having an inlet opening at 14 and an outlet opening at 16 (FIG. 2) where light leaves the fixture.

The housing has a flange 22 with corrugated section 20 near its outlet end 16, and a relatively straight neck portion 24 leading to the inlet 14.

Instead of the usual incandescent lamp or other screw-in lamp, an LED array 26 is positioned at the inlet opening just inside the housing. The LED array 26 emits its light through a convex lens 27 which tends to spread the light outwardly. Alternatively, other lenses could be provided to shape the output light beam as desired.

Referring to FIG. 2, as well as FIG. 4, the LED array 26 has a central array 70 of LED light elements, in a package having flanges 64 and a body portion (behind the array 70 in FIG. 4). The body portion extends through the opening 14 and makes contact with the flat bottom of a heat sink 28. The LED array is attached to the flat bottom of the heat sink preferably by heat-conducting silicone thermal glue. Thus, the body of the LED array makes intimate, heat-conducting contact with the bottom of the metal heat sink.

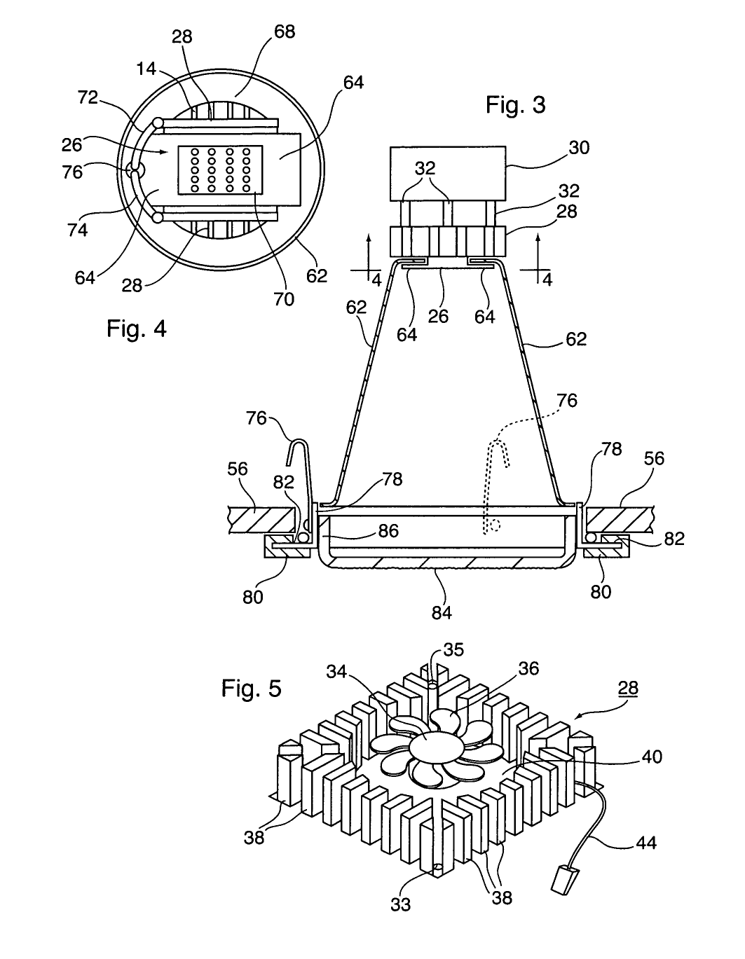

Referring to FIG. 2, as well as FIGS. 1 and 3, a power supply 30 is provided. It is mounted above and spaced from the upper surface of the heat sink 28 by screws and spacers 32 (not shown in FIG. 1). The power supply 30 may or may not have a cover such as that shown in FIGS. 2 and 3, and in dashed outline in FIG. 1.

Input leads 34 and 36 to the power supply are connected directly to the wiring of the building to supply the usual 120 Volts 60 Hz AC power. The power supply has a well-known construction. It typically uses a step-down transformer and a rectifier to convert AC voltage to 12 Volts DC for the fan motor, and 14 Volts DC for the LED array. Although separate power supplies can be provided for the two devices, a single power supply combining these functions is compact and relatively simple to mount and can be provided relatively inexpensively.

The preferred heat sink 28 and fan combination is shown in FIG. 5. The heat sink preferably is made out of aluminum or similar light-weight, inexpensive good heat-conducting material. The heat-sink has a hollowed-out body with a central cavity 40, and a plurality of fins 38. A fan 34 with blades 36 forces air upwardly and out between the fins to provide cooling.

The fan and heat sink combination shown in FIG. 5 is used for cooling VGA cards in computers. It is relatively inexpensive because it is manufactured in great quantities for use in computers around the world.

The fan 34 and heat-sink 28 combination is highly advantageous for use in the present invention in that its vertical height is quite small. This keeps the height of the structure above the inlet end of the lamp 12 housing relatively low. Thus, the fixture can be used in the space between the ceiling and floor in a building, as shown in FIG. 2, or in other cramped spaces without undue difficulty.

The power supply 30 preferably has a round, flat circuit board 31 (FIG. 1) on which the components are mounted. This board serves as a baffle for air from the fan, so as to insure that the air will travel sideways as indicated in FIG. 2 by the arrows 42. This additionally gives some cooling, if needed, to the power supply.

It is preferred that the power supply has a thermistor which will open the power circuit to the LED lamp if and when it overheats due to failure of the fan.

Referring again to FIG. 5, the heat sink 28 has mounting holes 33 and 35, but other mounting holes can be provided as needed.

The power supply cord 44 to the fan 34 is connected into the power supply 30 through connection which is not shown in the drawings.

Referring again to FIGS. 1 and 2, two pairs of spring arms, 46, 48, and 50 are provided on opposite sides of the housing 12. As it is well known, the spring arms are inserted into mounting receptacles, part of which are shown at 52, to retractably mount the fixture in the opening in the ceiling.

FIG. 2 shows the ceiling 56 and schematically shows the floorboards 58 of the floor above the ceiling 56. This provides an air space between the floorboards and the ceiling. That air space is indicated at 60 in FIG. 2.

In accordance with one highly advantageous feature of the invention, the air discharged from the fan is discharged directly into the air space 60 without the use of ducting or other expensive construction features. This is due to the realization that the air need not be vented into the room below or elsewhere because it is easily able to escape through the normal crevices and openings in building construction air spaces.

Furthermore, it is an advantage of the invention that the fans that are selected are very low volume in their output because the heat-sink and fan arrangement is so efficient in carrying heat away from LED lamp arrays. Therefore, the output air volume is relatively low, and the quantity of air that comes out is similarly low, and can be essentially negligible.

### Shower Fixture

FIG. 3 shows a shower lamp fixture which is like that shown in FIG. 2, with certain exceptions. A frustro-conical housing 62 is provided with a glass outlet cover 82 with a rough pebbled outer surface 84 and a bezle 80. A rubber seal (not shown) is provided between the bezle and the ceiling 56 to make the fixture reasonably watertight so it can be used readily in showers or other wet areas.

Three convenient hook fasteners 76 (only two of which are shown) are provided for the easy mounting of the fixture in a ceiling mounting structure, as is well known. The bezle 80 is secured to the lower flange 82 of the housing 62.

In other respects, the function of the structure of the fixture in FIG. 3 is like the one shown in FIGS. 1 and 2.

### Outdoor Light Fixtures

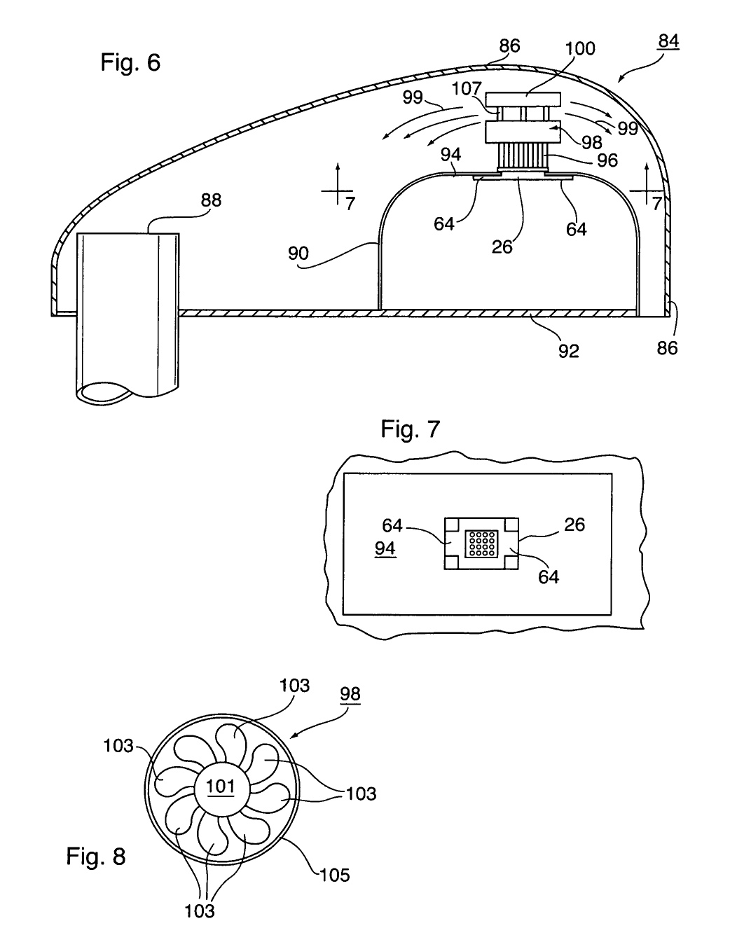

FIG. 6 is a cross-sectional view of a typical street lamp housing 86, which is mounted on a pole indicated schematically at 88, for street lighting purposes. Whereas the LED array used in the fixtures shown in FIGS. 1, 2 and 3 are relatively low power (e.g. 20 Watts to 50 Watts) which give illumination in the range of 60 Watt incandescent bulbs to 150 Watt incandescent bulbs, the street lighting fixture shown in FIG. 6 usually requires higher wattage for LED arrays, say 100 Watts or more. As a result, more cooling is required.

The LED array 26 is mounted in a reflector 90 within the housing 86 to reflect light from the LED lamp array outwardly through a window 92.

The fixture 84 shown in FIG. 6 has a singular fan 98 in a circular housing mounted on top of a heat sink 96, and a power supply is mounted at 100 above the fan 98. The fan 98 draws air upwardly though the heat sink 96 and spreads it sideways in the directions of the arrows 99.

Because there is more room in the housing of lighting fixture 84 than for the fixtures in FIGS. 1-5, there is sufficient room for the more powerful but taller fan 98 and heat-sink 96 combination to be used.

FIG. 8 is a top plan view of the fan 98. It has a circular housing 105 with a fan motor 101 with blades 103 mounted within the housing 99. The housing and fan are mounted on the heat sink 96 by screws and spacers 107.

Preferably, this fan, like the fan 34 used in the fixtures shown in FIGS. 1-3 is used in cooling computers. Specifically, it is used to cool the CPU units in desk-top and other computers.

Alternatively, a fan and heat-sink combination like that in FIGS. 1-5 but with a higher output volume can be used, in order to keep the profile low.

Again, the air from the fan is simply discharged into the interior of the housing 86, from which it escapes easily through the small crevices and gaps occurring in such structures.

### Specifications

The following LED arrays are typical examples of arrays which can be used:
20 Watt—white LED; brightness 1000 Lm
50 Watt—white LED; brightness 3500 Lm
100 Watt—white LED; brightness 8000 Lm

Following are the specifications of suitable fans and heat sinks:
Fan and heat-sink in FIGS. 1-5
Snowflake DC Brushless Cooling fan for PC VideoCard
Fan and heat-sink in FIGS. 6-8:
3000 RPM Quiet CPU Fan (12V DC).

The above description of the invention is intended to be illustrative and not limiting. Various changes or modifications in the embodiments described may occur to those skilled in the art. These can be made without departing from the spirit or scope of the invention.

1. An LED lamp fixture comprising
a. a housing having an inlet opening and an outlet opening
b. an LED lamp array mounted in said housing to shine light through said outlet opening,
c. a heat sink structure with fins and a flat heat-conducting surface,
d. said LED lamp array being secured directly to said flat heat-conducting surface, and
e. a fan mounted closely adjacent said heat sink and adapted and positioned to force air sideways through said fins

2. A lamp fixture as in claim 1 in which said heat sink structure has a hollow interior and said fan is mounted in said hollow interior.

3. A lamp fixture as in claim 1 in which said heat sink is mounted between said fan and said LED array and said fan pulls air through said heat sink structure.

4. A lamp fixture as in claim 1 in which said fan and said heat sink extend outwardly beyond said inlet opening outside of said housing.

5. A lamp fixture as in claim 1 in which said housing is adapted to be recessed in the ceiling of building with air from said fan exiting from said heat sink into the air space above said ceiling and having a power supply mounted on and extending above said heat sink with a space between said heat sink and power supply.

6. A lamp fixture as in claim 1 in which said housing has a light-reflecting interior surface, and an outer housing surface for protecting said lamp array from the elements for outdoor use.

7. A lamp fixture as in claim 6 and a lens mounted in said housing adjacent said LED lamp array to shape the beam of light issuing from said outlet opening.

8. A lamp fixture as in claim 1 in which said housing is selected from the group consisting of a down floodlight housing, a down shower housing, and a street light housing.

9. A lamp fixture as in claim 1 in which said housing is a sealed street light housing and the exhaust from said fan is discharged directly from said heat sink into said housing.

10. A lamp fixture as in claim 1 in which said housing inlet opening has an inwardly-extending lamp flange, said LED lamp array has a body and outwardly-extending flanges, said body extending through said inlet opening with said flanges overlapping said lamp flange and said flat surface of said heat sink secured to said body with said flat surface bearing against said lamp flange.

11. A lamp fixture as in claim 1 in which said fan is a computer cooling fan.

12. A lamp fixture as in claim 11 in which said fan is a computer VGA card cooling fan with the fan mounted inside of said heat sink.

13. A lamp fixture as in claim 11 in which said fan is a computer CPU cooling fan.

14. An LED down lamp mounted in the ceiling of a building with an internal air space between said ceiling and a floor above said ceiling, said lamp comprising a housing recessed in an opening in said ceiling, said housing having an inlet opening and an outlet opening shining light through said outlet opening and into a room of said building.
a. an LED lamp array mounted in said housing and secured to a heat sink having spaced-apart cooling fins,
b. a fan/heat sink combination comprising a fan mounted on said heat sink to cool said LED lamp array by forcing air from said internal air space through the spaces of said heat sink,
c. directing the exhaust from said fan into said internal air space to dissipate through naturally-occurring cracks, crevices and other openings in said building.

15. A lamp as in claim 14 including a power supply for supplying electrical power to said LED lamp array and said fan at the required voltage and power levels needed for operation, said power supply being mounted on, but spaced from, said fan/heat sink combinations to receive air flow from said fan.

16. A lamp as in claim 15 in which said power supply is mounted on a support surface facing said air flow so as to spread said air flow away from the sides of said lamp housing.

17. An LED lamp fixture comprising
a. a housing with an enclosure body having a window through which light can shine from within said housing and at least one air outlet opening in said enclosure body,
b. a support structure for supporting said housing on a mounting surface,
c. a reflector,
d. an LED lamp array mounted with respect to said reflector so that said reflector reflects light from said LED array out of said housing through said window,
e. a heat sink structure with fins and a flat heat-conducting surface, said LED lamp array beng secured directly to said flat heat-conducting surface, and
f. a fan mounted closely adjacent said heat sink and positioned to force air through said fins

18. A lamp fixture as in claim 1 in which said air outlet opening is at least one natural crevice in said enclosure body, and said heat sink structure has a hollow interior and said fan is mounted in said hollow interior.

19. A lamp fixture as in claim 17 in which said support structure includes a pole with said enclosure body secured to one end of said pole to be used for street lighting.
